(19) United States
(12) Patent Application Publication
(10) Pub. No.: US 2014/0290002 A1
(43) Pub. Date: Oct. 2, 2014

(54) DAMPING DEVICE FOR FURNITURE DOORS

(71) Applicant: Horst LAUTENSCHLÄGER, Reinheim (DE)

(72) Inventor: Horst LAUTENSCHLÄGER, Reinheim (DE)

(21) Appl. No.: 14/306,680

(22) Filed: Jun. 17, 2014

Related U.S. Application Data
(63) Continuation of application No. 12/993,124, filed on Nov. 17, 2010, now abandoned.

(30) Foreign Application Priority Data
May 21, 2008 (DE) 20 2008 006 909.2
Oct. 21, 2008 (DE) 20 2008 014 026.9

(51) Int. Cl. E05F 5/10; E05F 5/02

(52) U.S. Cl. CPC E05F 5/10; E05F 5/02
USPC 16/84

(57) ABSTRACT

A damping device for furniture doors includes a damping cylinder longitudinally displaceably mounted in a recess of a damper housing including a cylinder housing and a piston rod and forming a stop for the furniture door. The cylinder housing is longitudinally displaceably mounted in the recess of the damper housing, the recess being formed as a hole, the end thereof protruding out of the damper housing forming a stop for the furniture door. The adjusting screw forms an axial counterbearing for the piston rod. The inner diameter of an internal thread receiving the adjusting screw is at least equal to the inner diameter of the hole receiving the cylinder housing. The end of the piston rod is received in a centric hole of the adjusting screw.

present application is a continuation of application Ser. No. 12/993,124, filed Nov. 17, 2010, which is the U.S. National Stage of PCT/EP2009/003123, filed Apr. 30, 2009, which claims priority to DE 20 2008 006 909.2, filed May 21, 2008, and DE 20 2008 014 026.9, filed Oct. 21 2008, all of which are incorporated by reference.

### BACKGROUND AND SUMMARY

The invention relates to a damping device for furniture doors comprising a damping cylinder longitudinally displaceably mounted in a recess of a damper housing, comprising a cylinder housing and a piston rod and forming a stop for the furniture door, said damping cylinder being longitudinally adjustable by means of an adjusting screw on the back end of the recess that points away from the stop.

Different embodiments of damping devices for furniture doors are known. At the end of its closing motion the furniture door makes contact with the damping device and is slowed down until it is completely closed so that there is no undesirable sudden and forceful contact of the furniture door with the body of the piece of furniture or the face frame.

In many cases the damping device is connected to a furniture hinge (EP 1 538 293 B1). The damper housing can form a part of the furniture hinge or it can be fastened to the hinge.

In a known damping device as described in the introduction (DE 20 200 798 U1) the cylinder housing is arranged completely in the recess of the damper housing with said recess being an open recess towards the furniture side.

The piston rod that protrudes from the damper housing forms the stop for the furniture door. Towards the furniture door the cylinder housing of the damping cylinder rests on the damper housing by means of a pressure spring. At the opposite end the adjusting screw extends into the recess of the damper housing and forms a stop against which the cylinder housing is pushed by the pressure spring. When the adjusting screw is adjusted, the piston rod is moved out of the damper housing in varying lengths from its starting position so that the damper path is changed.

Since the piston rod is relatively thin it could get damaged, especially when the force exerted by the furniture door does not rim exactly in axial direction of the damping cylinder. The pressure spring that is required is an additional component that makes the design more complicated and increases the possibility of problems.

It is desirable to provide a damping device as the type described in the introduction that provides a simple design and an especially low susceptibility to problems and that allows for an especially easy adjustment.

In accordance with an aspect of the invention a cylinder housing is mounted longitudinally displaceably in the recess of the damper housing, said recess being formed as a hole, the end thereof protruding from the damper housing forming a stop for the furniture door, in that the piston rod is connected to the adjusting screw and in that the inner diameter of an internal thread receiving the adjusting screw is at least equal to the inner diameter of the hole receiving the cylinder housing.

Using the cylinder housing as a stop for the furniture door and the recess receiving the cylinder housing being formed as a hole, provide for an increase in stability of the damping device in which even additional lateral forces that act on the stop do not result in damage or jamming. By connecting the piston rod with the adjusting screw the damping cylinder is prevented from completely moving out of the hole of the damper housing.

Since the inner diameter of the internal thread into which the adjusting screw is screwed is equal to or larger than the diameter of the hole, the damping cylinder can be inserted through the internal thread into the hole of the damper housing during assembly. It is fixed only with the adjusting screw being screwed into the internal thread. No additional components, such as a pressure spring, are necessary. Even when the damping device is not yet fastened to the body of a piece of furniture, there is no danger that parts of it may fall out or get lost. The assembly of the damping device therefore is rather easy.

Since the adjusting screw is screwed in a longitudinally displaceable manner into the internal thread that runs concentrically to the hole, damping can simply be adjusted by turning the adjusting screw and thus screwing it more or less deep into the internal thread.

According to a preferred embodiment of the invention the end of the piston rod is received in a centric hole of the adjusting screw. The end of the piston rod is expediently pressed into the centric hole of the adjusting screw. This provides for a reliable connection of the adjusting screw and the piston rod in a simple manner from a manufacturing point of view.

According to an especially advantageous embodiment of the invention a pressure spring is arranged between the piston rod and the damper housing. The pressure spring therefore is arranged in the flow of force between the damping cylinder on which the door impinges and the damper housing that rests against the body of a piece of furniture. Since the damping force is determined by speed, there is a high peak of force during sudden, forceful operation, i.e. when the furniture door to be dampened shuts close at high speed, which can result in damage to the damping device, especially to the fastening of the damper housing on the body of a piece of furniture.

In such a case the pressure spring that is arranged in series in the flow of force of the damping force and the damping cylinder absorbs the peak of force; the course of force is flattened as long as a deformation trajectory of the pressure spring is available.

According to a preferred embodiment of the invention the pressure spring is arranged in an internal hole of the adjusting screw between a pressure body that is arranged on the piston rod and is longitudinally displaceable in the internal thread and a spring stop fixed in the adjusting screw. This results in a rather space-saving arrangement of the pressure spring that additionally is protected against damage and dirt.

Additional advantageous embodiments of the inventive thought are the subject of additional sub-claims.

### BRIEF DESCRIPTION OF THE DRAWINGS

The invention is explained in more detail with the help of an exemplary embodiment that is shown in the drawing. The following is shown:

FIG. 1 shows a cross section of a damping device for furniture doors at the beginning of the damping path,

FIG. 2 shows the damping device according to FIG. 1 at the end of the damping path with the furniture door being closed,

FIG. 3 shows the parts of the damping device when pulled apart,

FIG. 4 shows the longitudinal section of a damping device with pressure spring,

FIG. 5 shows a cross section of an enlarged partial presentation of a modified embodiment of the damping device and

FIGS. 6 and 7 show presentations of further modified embodiments of damping devices according to FIG. 4.

### DETAILED DESCRIPTION

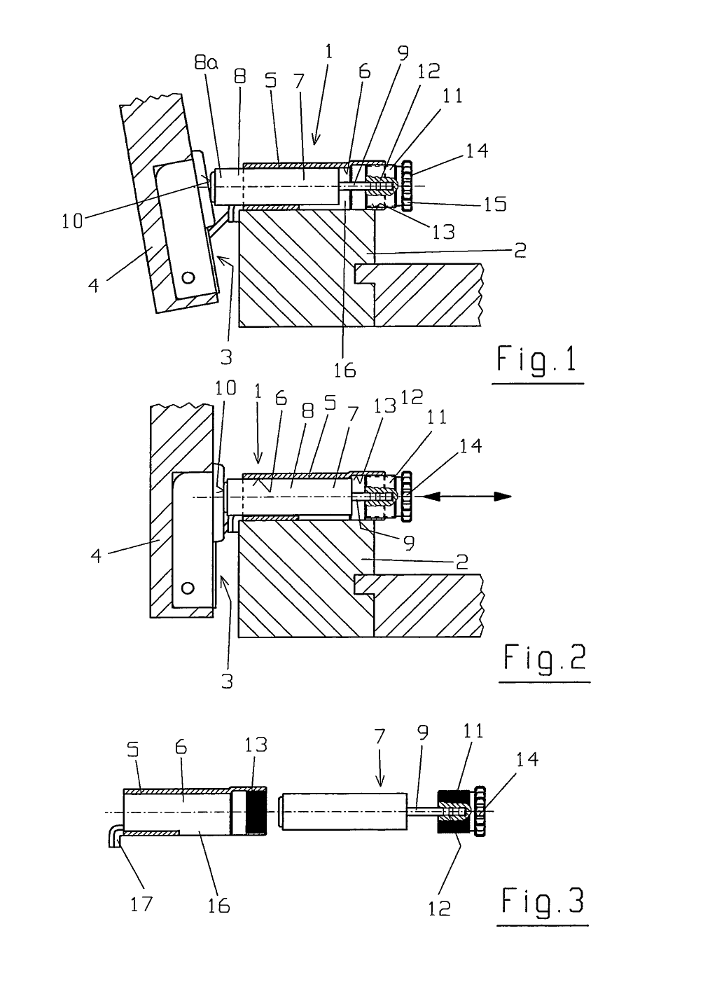

The damping device 1 shown in the drawing is attached to a face frame 2 of a piece of furniture that has a so-called “face frame design”. A furniture door 4 is articulated on the face frame 2 by means of at least two furniture hinges 3 that are shown only partially in FIGS. 1 and 2. The damping device 1 is used to dampen the closing motion of the furniture door 4.

The damping device 1 comprises a damper housing 5 that is arranged on the face frame 2. The damper housing 5 may be a separate component as is shown in the drawing. However, it can also he a part of the furniture hinge 3.

A hole 6 in the damper housing 5 forms a recess in which a damping cylinder 7 is received. The damping cylinder 7 comprises a cylinder housing 8 and a piston rod 9 that is connected to the damper piston (which is not shown). The cylinder housing 8 together with its end 8a that protrudes from the damper housing 5 forms a stop 10 for the furniture door 4. A buffer is expeditiously fastened to the stop 10, said buffer making contact with a metal surface of the door fitting of the furniture hinge 3 when the furniture door 4 is being closed.

The cylinder housing 8 is received in hole 6 of the damper housing 5 in a longitudinally displaceable manner. The end of the piston rod 9 is connected to an adjusting screw 11. In the exemplary embodiment shown the end of the piston rod 9 is received in a centric hole 12 of the adjusting screw 11. The connection of the piston rod 9 with the adjusting screw 11 is achieved by pressing. Alternatively, the end of the piston rod 9 also may be received in the hole 12 that is a blind hole in a longitudinally displaceable manner.

The adjusting screw 11 is screwed into an internal thread 13 that is concentric with regard to the axis of the hole 6 in the damper housing 5. The inner diameter of the internal thread 13 is at least equal, preferably larger—as shown in the drawing—than the inner diameter of the hole 6 that receives the cylinder housing 8.

The adjusting screw 11 comprises a handle section 14 that protrudes from the damper housing 5, said handle section comprising a knurling or another contour that facilitates the handling of the adjusting screw 11.

In the exemplary embodiment shown the hole 6 in the damper housing 5 has an opening 16 to the outside that rests against the face frame 2.

For assembly purposes the damping cylinder is inserted into the hole 8 with the adjusting screw 11 that is fastened to the piston rod 9, as is shown in FIG. 3. After the adjusting screw 11 is screwed into the internal thread 13, the damping device is completely assembled.

The damping effect is adjusted by turning the adjusting screw 11. As is indicted by the double arrow in FIG. 2, this causes the entire damping cylinder 7 to be adjusted in longitudinal direction so that the angle position is changed in which the furniture door 4 makes contact with the damping cylinder 7 (FIG. 1). Starting from this position the cylinder housing 8 of the damping cylinder 7 is moved against the piston rod 9 that is fixed in this position and thus against the damping piston inside the damping cylinder 8 when the furniture door 4 is swiveled further. This dampens the furniture door 4 during its swiveling motion between the positions according to FIGS. 1 and 2.

The support of the resulting damping force is provided by a bent 17 of the damper housing 5 on the door side that rests against the face area of the face frame 2. Additional measures for fixing the damper housing 5 on the face frame 2 with screws or other means are possible, but are not shown in the drawing.

The damping device 1 can accordingly be fastened to the face edge of a body of a piece of furniture as well.

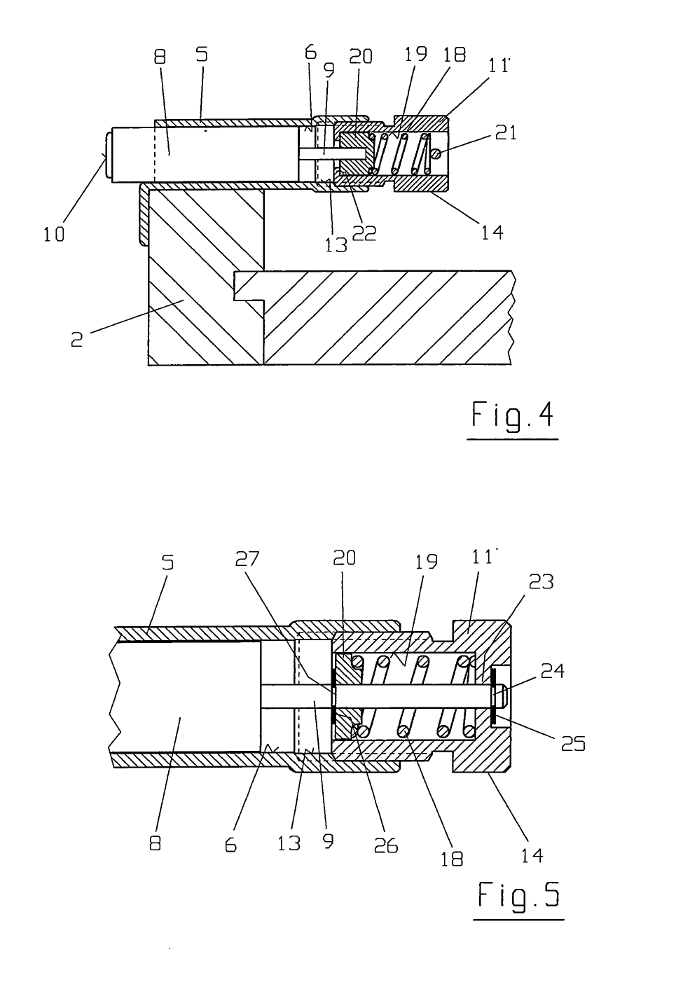

The exemplary embodiments shown in FIG. 4-7 are different from the above described exemplary embodiments substantially in that a pressure spring 18 is arranged in series with the damping cylinder 8 between the piston rod 9 and the damper housing 5.

The pressure spring 18 is arranged in an internal hole 19 of the adjusting screw 11′. The pressure spring 18 is received between a pressure body 20 and a spring stop 21 that is pre-stressed and fixed in the adjusting screw 11.

The pressure body 20 that is longitudinally displaceable in the internal hole 19 is fixed to the piston rod 9 that ends in the pressure body 20. In the starting position shown in FIG. 4 the pressure body 20 its against a stop 22 of the adjusting screw 11′, said stop being formed by an edge protruding radially to the inside horn the end of the internal hole 19. In the embodiment according to FIG. 4 the spring stop 21 is comprised of a lateral pin arranged on the adjusting screw 11′.

When the furniture door 4 hits the damping cylinder 8 abruptly at high speed, the velocity-based damper force is very high. The abrupt force is transmitted almost undiminished onto the piston rod 9 whose end is fixed to the pressure body 20. The resulting peak of force causes the pressure body 20 to move out of the way while the pressure spring 18 is being deformed. This causes the pressure peak to weaken substantially before the pressure body 20 comes to a standstill on the block in the adjusting screw 11′ due to the deformation of the pressure spring 18. This prevents the initial pressure peak to act undiminished on the damper housing 5 and its fastening on the face frame 2 of the body of the piece of furniture.

The partial section of the exemplary embodiment shown in FIG. 5 is different from the embodiment according to FIG. 4 substantially in that the piston rod 9 protrudes from an end hole 23 of the adjusting screw 11′ on the end of the adjusting screw 11′ pointing away from the damping cylinder 8 and comprises a radially extending retaining projection that is a snap ring 25 arranged in a peripheral groove 24 of the piston rod 9 in the exemplary embodiment shown.

The pressure body 20 that is received in the internal hole 19 against the force of the pressure spring 18 in a displaceable manner rests against a snap ring 26 that is received in a peripheral groove 27 of the piston rod 9.

When the damping force exerted by the piston rod 9 is higher than the pre-stressing of the pressure spring 18, the piston rod 9 moves the pressure body 20 against the pressure spring 18 by means of the snap ring 26 whereby the end of the piston rod 9 moves out of the end hole 23.

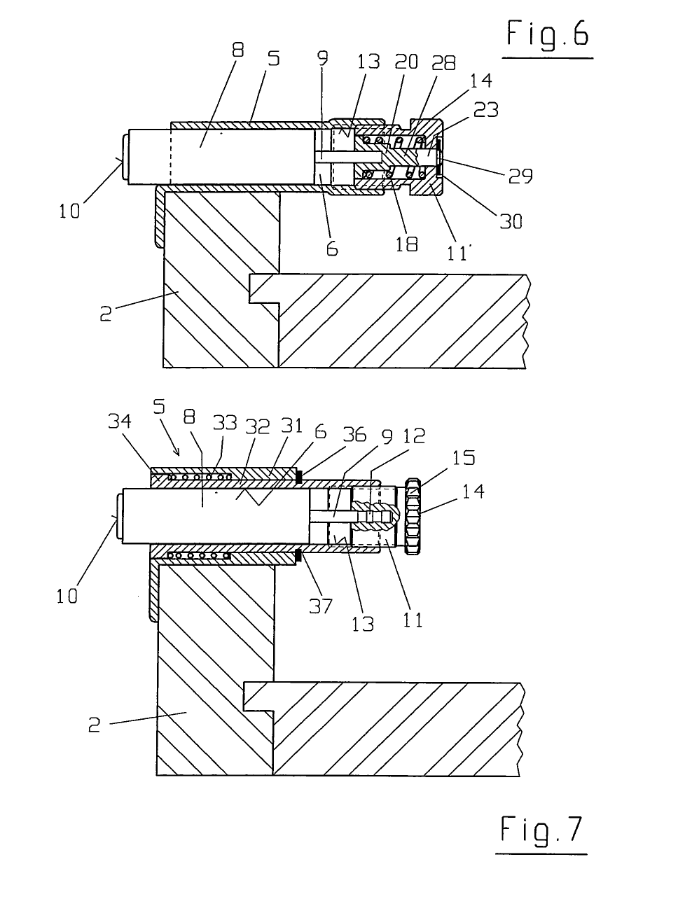

In the embodiment of the damping device according to FIG. 6 the piston rod 9 ends in the pressure body 20. The pressure body 20 comprises a centric sliding journal 28 on its side that faces away from the damping cylinder 8 (right side in FIG. 6), said sliding journal protruding from the end hole 23 of the adjusting screw 11′ and carrying a snap ring 30 in a peripheral groove 29.

In the embodiment shown in FIG. 7 the damper housing 5 is comprised of an external housing part 31 that is fixed to the face frame 2 and an internal housing part 32 that is arranged in a longitudinally displaceable manner on the inside, said internal housing receiving the cylinder housing 8 in a longitudinally displaceable manner in its hole 6.

A pressure spring 33 is arranged between the external housing part 31 and the internal housing part 32 and concentrically surrounds the internal housing part 32. The pressure spring 33 is received and pre-stressed between an outside collar 34 of the internal housing part 32 and a collar protruding to the inside 35 of the external housing part 31 and are pre-stressed. A snap ring 36 that is received in a peripheral groove 37 of the internal housing part supports the longitudinally displaceable internal housing part 32 against the force of the pressure spring 33 on the face of the external housing part 31.

If, due to high contact speed of the furniture door a high degree of force acts on the piston rod 9 that is fixed in the adjusting screw 11, the internal housing part 32 is moved against the force of the pressure spring 33 in the external housing part 31 to the right in FIG. 7. The force peak that acts on the external housing part 31 of the damper housing 5 and thus on its fastening on the face frame 2 is reduced considerably in the above described manner.

1. A damping device for a furniture door, comprising
a damper housing comprising a recess,
a damping cylinder longitudinally displaceably mounted relative to the recess, the damping cylinder comprising a cylinder housing displaceably mounted in a hole of the recess and a piston rod, a portion of the cylinder housing at a first end of the damping cylinder protruding out of a front end of the recess and forming a stop fur the furniture door, and
an adjusting screw, the damping cylinder being longitudinally adjustable relative to the damper housing by the adjusting screw, the adjusting screw having external threads that mate with internal threads of the recess so that the adjusting screw is movably attached on a back end of the recess,
wherein the piston rod is connected to the adjusting screw and an inner diameter of the internal threads of the recess is at least as large as an inner diameter of the hole in which the cylinder housing is mounted.

2. The damping device according to claim 1, wherein an end of the piston rod is received in a centric hole of the adjusting screw.

3. The damping device according to claim 2, wherein the end of the piston rod is pressed into the centric hole of the adjusting screw.

4. The damping device according to claim 2, wherein the end of the piston rod is received in a longitudinally displaceable manner in the centric hole of the adjusting screw, the centric hole being a blind hole.

5. The damping device according to claim 1, wherein the adjusting screw comprises a handle section that protrudes from the damper housing and comprises a knurling contour.

6. The damping device according to claim 1, wherein a pressure spring is arranged between the piston rod and the damper housing.

7. The damping device according to claim 6, wherein the pressure spring is arranged in an internal hole of the adjusting screw between a pressure body that is fixed to the piston rod and is longitudinally displaceable in the internal hole, and a spring stop fixed in the adjusting screw.

8. The damping device according to claim 7, wherein the pressure body is supported against a of snap ring that is received in a peripheral groove of the piston rod.

9. The damping device according to claim 7, wherein the pressure spring is compressed between the pressure body and the spring stop.

10. The damping device according to claim 7, wherein the pressure body rests against a stop of the adjusting screw when the pressure body is in a least-compressed starting position.

11. The damping device according to claim 7, wherein the piston rod protrudes from an end hole of the adjusting screw on an end of the adjusting screw facing away from the damping cylinder and the piston rod comprises a radial retaining projection.

12. The damping device according to claim 8, wherein the piston rod ends in the pressure body and the pressure body comprises a centric sliding journal on a side thereof that faces away from the damping cylinder, the sliding journal protruding from an end hole of the adjusting screw and having a radial retaining projection.

13. The damping device according to claim 11, wherein the retaining projection is a snap ring received in a peripheral groove of the piston rod.

14. The damping device according to claim 6, wherein the damper housing comprises an external housing pa and an internal housing part arranged therein in a longitudinally displaceable manner, the damper housing receiving the cylinder housing in the hole in a longitudinally displaceable manner and the pressure spring being arranged between the external housing part and the internal housing part.

15. The damping device according to claim 14, wherein the pressure spring surrounds the internal housing part in a concentric manner.
